(19) United States
(12) Patent Application Publication
(10) Pub. No.: US 2006/0058064 A1
(43) Pub. Date: Mar. 16, 2006

(54) Mobile communication terminal

(75) Inventor: Kouichi Satou, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/530,734

(22) PCT Filed: Dec. 18, 2002
(86) PCT No.: PCT/JP02/13254

§ 371 Date: Apr. 8, 2005

(51) Int. Cl. H04B 1/38

(52) U.S. Cl. 455/558; 455/411

(57) ABSTRACT

When an IC card is inserted into a mobile communication terminal, a reading unit reads the identification number of the IC card from the IC card and then notifies it to an identification unit, and the identification unit determines whether or not the acquired information is stored in a storage unit. When the identification number of the inserted IC card is not stored in the storage unit, the identification unit makes a request of a display unit to display a request to input a password peculiar to the portable telephone terminal. The identification unit then recognizes a password input by a user, and, when determining that the input password differs from the password peculiar to the portable telephone terminal, makes a request of a locking unit to lock the portable telephone terminal. The locking unit then locks the portable telephone terminal so as to disable it.

### FIELD OF THE INVENTION

The present invention relates to a mobile communication terminal provided with a function of preventing itself from being used fraudulently.

### BACKGROUND OF THE INVENTION

There has been proposed a technology for preventing a mobile communication terminal, such as a cellular phone or a car telephone, from being used fraudulently when the mobile communication terminal falls into the hands of another person against the owner's intention, for example. As an example of this technology, there has been provided a mobile communication terminal in which an IC card in which an ID code, such as a telephone number preset for the owner of the mobile communication terminal (i.e., a subscriber), as well as the owner's personal data, is stored is attached to the main body of the telephone so that the mobile communication terminal can carry out telephone calls, the mobile communication terminal being able to disable the IC card so as to restrict unauthorized use thereof by transmitting a disable code to the IC card. For example, JP, 11-177682, A (see pages 3 to 5 and FIG. 1) discloses this type of radio communication equipment.

In a case of a mobile communication terminal which can carry out telephone calls when an IC card is attached thereto, accounting to telephone calls is carried out for the owner of the IC card. Since the above-mentioned related art mobile communication terminal can prevent any unauthorized use thereof by disabling the IC card, it can prevent phonecall charges due to unauthorized use thereof from being put on the authorized owner of the mobile communication terminal. A problem with this method is however that when a user attaches an IC card which he or she has got legally to the mobile communication terminal which he or she has got illegally, he or she can use the mobile communication terminal itself with no holds barred.

### DISCLOSURE OF THE INVENTION

The present invention is made in order to solve the above-mentioned problem, and it is therefore an object of the present invention to provide a mobile communication terminal which can restrict use thereof when the user attaches an IC card which he or she has got legally to the mobile communication terminal which he or she has got illegally.

A mobile communication terminal in accordance with the present invention includes a storage unit for storing the identification numbers of IC cards, and an identification processing unit for determining whether or not the identification number of an IC card connected to the mobile communication terminal is stored in the storage unit, and for determining whether or not the mobile communication terminal is being fraudulently used when the identification number of the IC card is not stored in the storage unit.

Therefore, the mobile communication terminal in accordance with the present invention can prevent itself from being fraudulently used when a user has got the mobile communication terminal illegally and then attaches an IC card which he or she has got legally to the mobile communication terminal.

### BRIEF DESCRIPTION OF THE FIGURES

FIG. 1 is a diagram showing a portable telephone terminal in accordance with embodiment 1 of the present invention;

FIG. 2 is a block diagram of the portable telephone terminal in accordance with embodiment 1 of the present invention;

FIG. 3 is a flow chart showing a procedure of determining whether or not the portable telephone terminal in accordance with embodiment 1 of the present invention is being used fraudulently;

FIG. 4 is a diagram showing communications between a portable telephone terminal according to embodiment 2 of the present invention and a base station;

FIG. 5 is a block diagram of the portable telephone terminal according to this embodiment 2;

FIG. 6 is a flow chart showing a procedure of determining whether or not the portable telephone terminal in accordance with embodiment 2 of the present invention is being used fraudulently;

FIG. 7A is a diagram showing information stored in a related art portable telephone terminal; and

FIG. 7B is a diagram showing information stored in a portable telephone terminal in accordance with embodiment 3 of the present invention.

### PREFERRED EMBODIMENTS OF THE INVENTION

In order to explain the invention in greater detail, the preferred embodiments of the invention will be explained below with reference to the accompanying figures.

### Embodiment 1

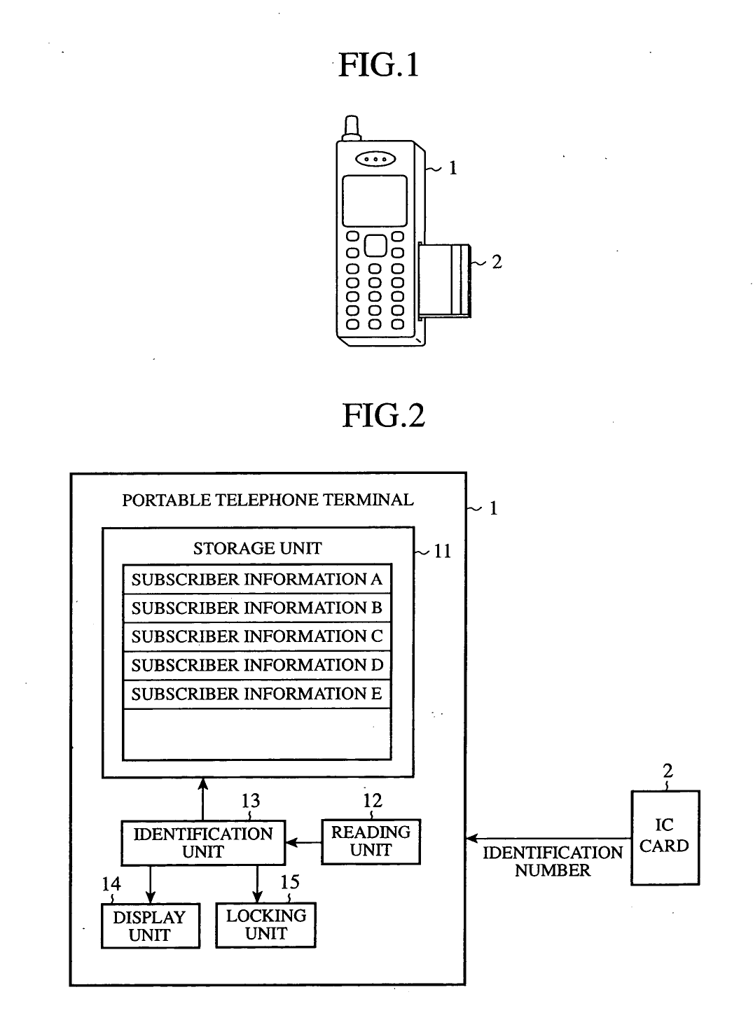

FIG. 1 is a diagram showing a portable telephone terminal in accordance with this embodiment 1. The portable telephone terminal (i.e., a mobile communication terminal) 1 is provided with a slot (not shown) disposed on a side or back surface thereof, to and from which an IC card 2 can be attached and detached. When the IC card 2 is inserted into this slot, the portable telephone terminal is electrically connected with the IC card 2. A subscriber's (or an owner's) identification number is stored in the IC card 2. When this IC card 2 is inserted into the portable telephone terminal 1, the portable telephone terminal 1 can be made to communicate with a base station so that the user can talk over the telephone.

FIG. 2 is a block diagram of the portable telephone terminal 1. As shown in this figure, the portable telephone terminal 1 is provided with a storage unit 11, a reading unit 12, an identification part (i.e., an identification processing unit) 13, a display unit (i.e., the identification processing unit) 14, and a locking unit (i.e., the identification processing unit) 15.

The identification numbers of IC cards which have been used by the terminal 1, and subscriber information, such as memory dial data including the names and phone numbers of persons which can be at the other end of the phone and which are registered therein, data on a record of incoming calls, stored e-mails, are stored in the storage unit 11. The information stored in the storage unit can be at least information about an IC card which was used latest, or can be at most information about all IC cards which have been used in the past. FIG. 2 shows that plural pieces of subscriber information A to E about authorized users A to E which have used the terminal 1 are stored in the storage unit 11, for example. A peculiar password preset by the manufacturer of the terminal 1 is also stored in the storage unit 11.

When the IC card 2 is inserted into the portable communication terminal, the reading unit 12 reads the identification number of the IC card 2 from the IC card and then notifies it to the identification unit 13. The identification unit 13 then determines whether or not the acquired identification number is stored in the storage unit 11. When the acquired identification number is not stored in the storage unit 11, the identification unit 13 makes a request of the display unit 14 to display a request for input of the password peculiar to the portable telephone terminal 1. The display unit 14 then performs display of the request for input of the password peculiar to the portable telephone terminal 1. The identification unit 13 recognizes a password inputted by a user, and, when determining that the inputted password differs from the password peculiar to the portable telephone terminal 1, makes a request of the locking unit 15 to lock the portable telephone terminal. The locking unit 15 then locks the portable telephone terminal 1 so as to disable it.

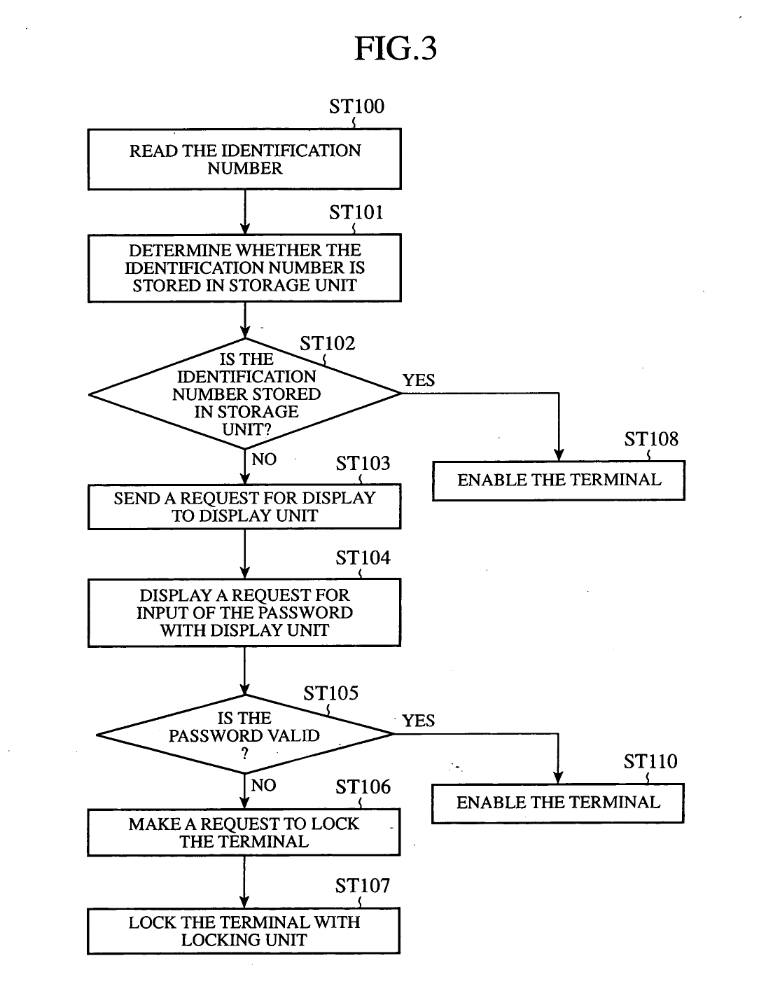

FIG. 3 is a flow chart showing a procedure of determining whether or not the portable telephone terminal 1 in accordance with this embodiment 1 is being used fraudulently, and the operation of the portable telephone terminal 1 will be explained with reference to this figure.

Plural pieces of subscriber information ‘A’ to ‘E’ about IC cards which have been used by the portable telephone terminal are stored in the storage unit 11 of the portable telephone terminal 1. When a user inserts an IC card 2 into the portable telephone terminal 1, the reading unit 12 reads the identification number stored in the IC card 2 and then notifies it to the identification unit 13 (in step ST100). The identification unit 13 then determines whether or not the identification number acquired from the reading unit 12 is stored in the storage unit 11 (in step ST101). When the identification number is not stored in the storage unit 11, the identification unit 13 determines that the user who is using this terminal 1 is a new subscriber, an authorized borrower, or an unauthorized user (in step ST102).

The identification unit 13 makes a request of the display unit 14 to display a request for input of the password peculiar to the portable telephone terminal 1 (in step ST103). The display unit 14 then performs display of making a request of the user to input the password peculiar to the portable telephone terminal 1 (in step ST104). The identification unit 13 recognizes a password which the user inputs in response to this display and then determines whether the inputted password matches with the password peculiar to the terminal 1 (in step ST105). When determining that the inputted password does not match with the password peculiar to the terminal 1, the identification unit 13 makes a request of the locking unit 15 to lock the terminal 1 (in step ST106). The locking unit 15 locks the terminal 1 so as to disable it (in step ST107).

Therefore, when a user inserts an IC card 2 which he or she has got legally into the terminal 1 which he or she has got legally, the identification unit, in step ST102, determines that the identification number of the IC card is stored in the storage unit 11 and enables the terminal 1 (in step ST108). On the other hand, when a user inserts a new IC card into the terminal 1 which he or she has got legally, the identification unit enables the terminal 1 as long as the user, in step ST105, inputs a valid password to the terminal 1 (in step ST110).

As mentioned above, according to this embodiment 1, the portable telephone terminal 1 is provided with the storage unit 11 for storing the identification numbers of IC cards which have been used by the portable telephone terminal, and subscriber information, and, when a user connects an IC card to the portable telephone terminal and the identification number of the IC card is not stored in the storage unit 11, makes a request of the user to input the password peculiar to the terminal 1. Therefore, the present embodiment offers an advantage of being able to, when a user attaches an IC card which he or she has got legally to the mobile communication terminal which he or she has got illegally, prevent the mobile communication terminal from being used fraudulently.

In step ST104, the display unit 14 can alternatively make a display of making a request of the user to input not only the password peculiar to the terminal 1 but a password assigned to the IC card 2. In this case, only when both the inputted password, which is assumed to be peculiar to the terminal 1, and the inputted password of the IC card 2 are authorized ones, the identification unit enables the terminal. Therefore, the mobile communication terminal can prevent use thereof even when any user attaches an IC card which he or she has got illegally to the mobile communication terminal which he or she has got legally.

### Embodiment 2

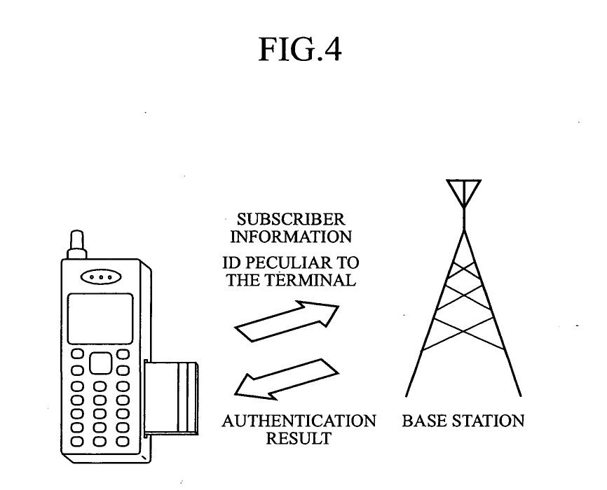

FIG. 4 is a diagram showing communications between a portable telephone terminal in accordance with this embodiment 2 and a base station. The portable telephone terminal 1 shown in the figure can carry out communications when an IC card 2 is inserted thereinto, like that of embodiment 1. A subscriber's (i.e., an owner's) identification number is stored in the IC card 2. Usually, when the terminal or the IC card has been stolen, the subscriber makes contact with a business firm with which he or she makes a contract for the subscription. On this occasion, the business firm registers both the ID of the theft terminal and the identification number and subscriber information of the theft IC card, as theft information about the subscriber, in response to the contact from the subscriber. The terminal can acquire information about the theft terminal or the theft IC card which is retrieved based on the above-mentioned theft information via a base station.

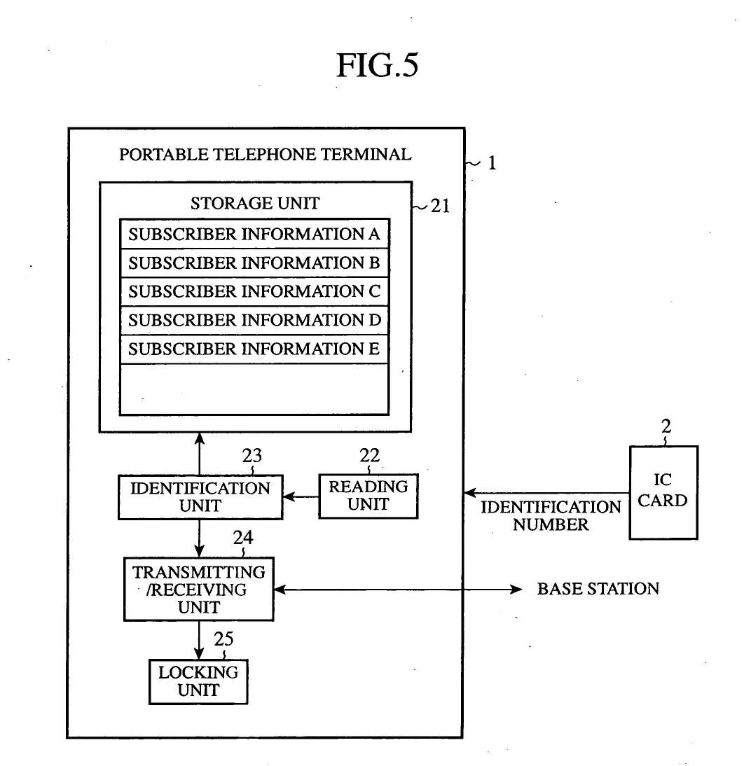

FIG. 5 is a block diagram of the portable telephone terminal 1. As shown in this figure, the portable telephone terminal 1 is provided with a storage unit 21, a reading unit 22, an identification unit (i.e., an identification processing unit) 23, a transmitting/receiving unit (i.e., the identification processing unit) 24, and a locking unit (i.e., the identification processing unit) 25.

The identification numbers of IC cards which have been used by the terminal 1, and subscriber information, such as memory dial data including the names and phone numbers of persons which can be at the other end of the terminal 1 and which are registered therein, data on a record of incoming calls, stored e-mails, are stored in the storage unit 21. The information stored in the storage unit can be at least information about an IC card which was used latest, or can be at most information about all IC cards which have been used in the past. FIG. 5 shows that plural pieces of subscriber information A to E about authorized users A to E which have used the terminal 1 are stored in the storage unit 21, for example. An ID peculiar to the terminal 1, such as the phone number of the terminal 1, is also stored in the storage unit 21.

When an IC card 2 is inserted into the portable communication terminal, the reading unit 22 reads the identification number of the IC card 2 from the IC card and then notifies it to the identification unit 23. The identification unit 23 then determines whether or not the acquired identification number is stored in the storage unit 21. When the acquired identification number is not stored in the storage unit 21, the identification unit 23 makes a request of the transmitting/receiving unit 24 to perform authentication of the IC card and the terminal. The transmitting/receiving unit 24 transmits both the identification number of the inserted IC card 2 and the ID peculiar to the terminal 1 to a base station. The base station performs authentication of the IC card 2 and the terminal 1. When neither information about the IC card 2 nor information about the terminal 1 is registered in the theft information stored in the base station, the base station transmits information indicating “authorized”, as an authentication result, to the transmitting/receiving unit 24. In contrast, when either information about the IC card 2 or information about the terminal 1 is registered in the theft information stored in the base station, the base station transmits information indicating “unauthorized”, as the authentication result, to the transmitting/receiving unit 24. When the authentication result indicates “authorized”, the identification unit enables the terminal 1. In contrast, when the authentication result indicates “unauthorized”, the transmitting/receiving unit 24 makes a request of the locking unit 25 to lock the portable telephone terminal. The locking unit 25 then locks the portable telephone terminal 1 so as to disable it.

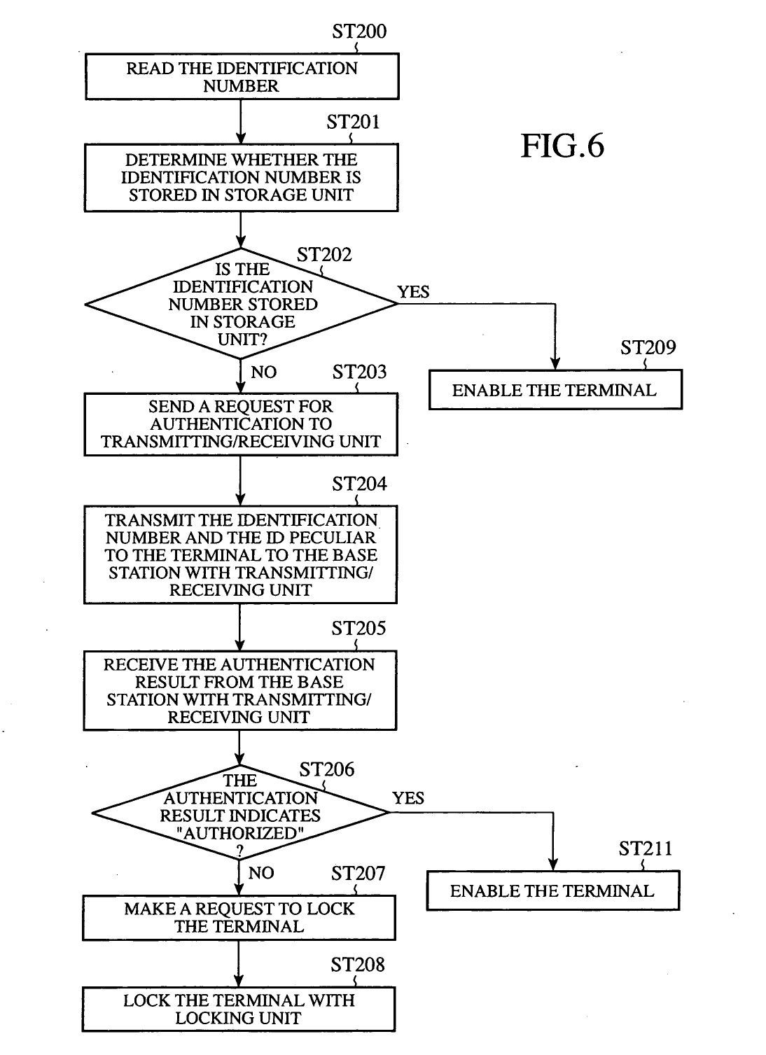

FIG. 6 is a flow chart showing a procedure of determining whether or not the portable telephone terminal 1 in accordance with this embodiment 2 is being used fraudulently, and the operation of the portable telephone terminal 1 will be explained with reference to this figure.

Plural pieces of subscriber information ‘A’ to ‘E’ about IC cards which have been used by the portable telephone terminal are stored in the storage unit 21 of the portable telephone terminal 1. When a user inserts an IC card 2 into the portable telephone terminal 1, the reading unit 22 reads the identification number stored in the IC card 2 and then notifies it to the identification unit 23 (in step ST200). The identification unit 23 then determines whether or not the identification number acquired from the reading unit 22 is stored in the storage unit 21 (in step ST201). When the identification number is not stored in the storage unit 21, the identification unit 23 determines that the user who is using this terminal 1 is a new subscriber, an authorized borrower, or an unauthorized user (in step ST202).

The identification unit 23 makes a request of the transmitting/receiving unit 24 to perform authentication of the IC card and the terminal (in step ST203). The transmitting/receiving unit 24 transmits both the identification number read from the IC card 2 and the ID peculiar to the terminal 1 to the base station (in step ST204). The base station performs authentication of the identification number of the IC card 2 and the ID of the terminal 1 which are transmitted thereto. When determining with either the terminal 1 or the IC card 2 is a stolen item, the base station provides an authentication result indicating “unauthorized”, whereas when determining that both the terminal 1 and the IC card 2 are things which the user has got legally, the base station provides an authentication result indicating “authorized”. The base station transmits the authentication result to the transmitting/receiving unit 24 (in step ST205).

When the authentication result transmitted from the base station indicates “unauthorized” (in step ST206), the transmitting/receiving unit 24 makes a request of the locking unit 25 to lock the terminal (in step ST207). The locking unit 25 then locks the terminal 1 so as to disable it (in step ST208).

When a user inserts an IC card 2 which he or she has got legally into the terminal 1 which he or she has also got legally, the identification unit, in step ST202, determines that the identification number of the IC card 2 is stored in the storage unit 21 and then enables the terminal 1 (in step ST209). In addition, when a user inserts a new IC card into the terminal 1 which he or she has got legally, the identification unit enables the terminal 1 as long as the authentication result transmitted from the base station indicates “authorized” (in step ST211).

As mentioned above, according to this embodiment 2, the identification unit transmits both the identification number of an inserted IC card and the ID peculiar to the portable telephone terminal to a base station so as to make the base station perform authentication of the IC card and the terminal, and then locks the terminal when the authentication result from the base station indicates “unauthorized”. Therefore, the present embodiment offers an advantage of being able to, when a user attaches an IC card which he or she has got legally to the mobile communication terminal which he or she has got illegally, prevent the mobile communication terminal from being used fraudulently. Furthermore, the mobile communication terminal can prevent fraud use thereof even though any user has got the mobile communication terminal legally and attaches an IC card which he or she has got illegally to the mobile communication terminal.

### Embodiment 3

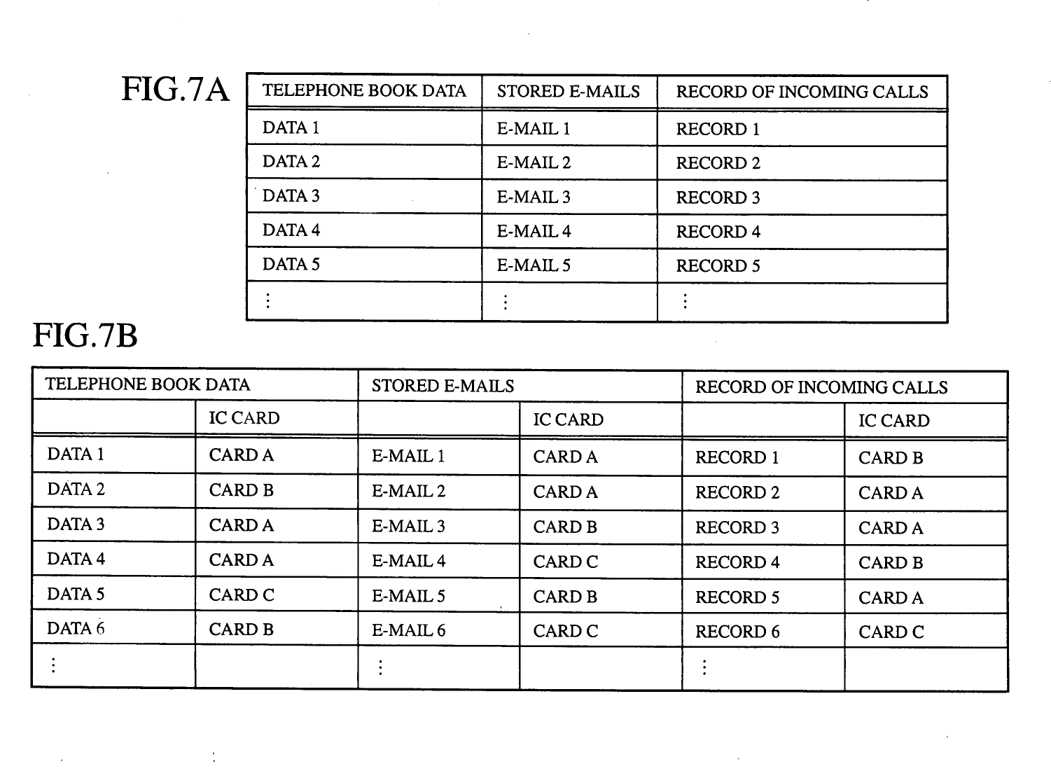

FIG. 7A is a diagram showing information stored in a related art portable telephone terminal, and FIG. 7B is a diagram showing information stored in a portable telephone terminal in accordance with embodiment 3 of the present invention. Since data in the form as shown in FIG. 7A are stored in a related art portable telephone terminal, when an authorized IC card is inserted into the portable telephone terminal, all information stored in the terminal can be read by the IC card. In contrast, according to this embodiment 3, telephone book data, stored e-mails, a record of incoming calls, etc., are stored for each of a plurality of available IC cards, as well as the identification number of each of the plurality of IC cards, as shown in FIG. 7B. Therefore, the portable telephone terminal in accordance with this embodiment can restrict data which can be read for every IC card inserted thereto.

The portable telephone terminal in accordance with this embodiment 3 has the same structure as shown in FIG. 2. For example, when a user A tries to insert an IC card having an identification number ‘A’, which he or she has got legally, into the portable telephone terminal which he or she has also got legally, to use the portable telephone terminal, a reading unit 12 reads the identification number ‘A’ and notifies it to an identification unit 13. The identification unit 13 determines whether or not the identification number ‘A’ notified thereto from the reading unit 12 is stored in a storage unit 11. When determining that the identification number ‘A’ is stored in the storage unit 11, the identification unit enables the user to use only the subscriber information specified by the identification number ‘A’. That is, the identification unit 13 makes a request of a locking unit 15 to lock access to any other information except the subscriber information specified by the identification number ‘A’ so as to disable the use of any other information except the subscriber information. The locking unit 15 locks access to any other information except the subscriber information specified by the identification number ‘A’ in response to this request. For example, in the case of the data shown in FIG. 7B, the user A can browse telephone book data 1, 3, and 4, stores e-mails 1 and 2, and records of incoming calls 2, 3, and 5.

Since the portable telephone terminal is so constructed as to lock access to any other information except subscriber information specified by an identification number corresponding to an IC card inserted thereto, as mentioned above, when a user F inserts an IC card which he or she has got illegally into the portable telephone terminal which he or she has also got illegally, for example, the portable telephone terminal locks access to all subscriber information stored therein so as to prevent any information stored therein from leaking to the unauthorized user F. Even when preventing unauthorized use by using this method, there is a possibility that information stored in the portable telephone terminal may leak to unauthorized users if an identical person gets an IC card and the terminal illegally. In order to solve this problem, a method, as explained in Embodiment 1, of making a request for input of a password peculiar to an IC card inserted to the terminal can be combined with the above-mentioned method. As an alternative, a method, as disclosed in JP, 11-177682, A, of disabling an IC card inserted to the terminal by causing a base station to transmit a disable code to the terminal according to a notification can be combined with the above-mentioned method. As an alternative, the portable telephone terminal can urge a user who has got an IC card and the portable telephone terminal legally to input a password peculiar thereto and allow the user to browse all information stored therein when recognizing that the user has input the password peculiar thereto.

As mentioned above, the portable telephone terminal according to this embodiment 3 locks access to any information except subscriber information specified by the identification number corresponding to an IC card inserted thereto, which is included in all subscriber information stored in the portable telephone terminal. Therefore, the present embodiment offers an advantage of being able to allow the user to read only required information, thereby improving the convenience of users and increasing the security of the portable telephone terminal.

Although the present invention has been illustrated and described in detail with reference to its preferred embodiments, it is understood by those skilled in the art that various changes in the form and minor details of the construction may be made in the invention without departing from the spirit and scope of the invention as hereinafter claimed. The applicant therefore intends in the appended claims to cover all such changes, replacements, and modifications as fall within the scope of the invention.

### INDUSTRIAL APPLICABILITY

As mentioned above, the mobile communication terminal according to the present invention includes a storage unit for storing the identification numbers of IC cards, and an identification processing unit for determining whether or not the identification number of an IC card connected to the mobile communication terminal is stored in the storage unit, and for determining whether or not the mobile communication terminal is being fraudulently used when the identification number of the IC card is not stored in the storage unit. Therefore, the present invention offers an advantage of being able to prevent use of the mobile communication terminal when a user has got the mobile communication terminal illegally and attaches an IC card which he or she has got legally to the mobile communication terminal.

1. A mobile communication terminal which can be made to communicate with a base station when being connected with an IC card that stores an identification number peculiarly assigned thereto and a subscriber's personal information, characterized in that said mobile communication terminal comprises:
a storage unit for storing identification numbers of IC cards; and
an identification processing unit for determining whether or not an identification number of an IC card connected to said mobile communication terminal is stored in said storage unit, and for determining whether said mobile communication terminal is being fraudulently used when the identification number of the IC card connected to said mobile communication terminal is not stored in said storage unit.

2. The mobile communication terminal according to claim 1, characterized in that said identification processing unit makes a request for input of a password peculiar to the mobile communication terminal, and, when accepting a wrong password, disables the mobile communication terminal.

3. The mobile communication terminal according to claim 1, characterized in that said identification processing unit transmits both the identification number of the IC card connected to the mobile communication terminal, and an ID peculiar to the mobile communication terminal to the base station so as to make a request of the base station to perform authentication of the IC card, and, when receiving a result indicating that the IC card is an unauthorized one from the base station, disables said mobile communication terminal.

4. A mobile communication terminal which can be made to communicate with a base station when being connected with an IC card that stores an identification number peculiarly assigned thereto and a subscriber's personal information, characterized in that said mobile communication terminal comprises:
a storage unit for storing identification numbers of IC cards and subscribers' personal information; and
an identification processing unit for disabling information except a subscriber's personal information corresponding to an identification number which is stored in said storage unit and is also stored in an IC card connected to said mobile communication terminal.
